(19) United States
(12) Patent Application Publication
(10) Pub. No.: US 2026/0128453 A1
(43) Pub. Date: May 7, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kotaro TAKADA, Osaka (JP); Osamu NAKAYAMA, Osaka (JP); Katsushi MIYAZAKI, Osaka (JP); Daiki TSUJI, Osaka (JP)

(21) Appl. No.: 19/117,404

(22) PCT Filed: Oct. 2, 2023
(86) PCT No.: PCT/JP2023/035900

§ 371 Date: Apr. 1, 2025

(30) Foreign Application Priority Data
Oct. 6, 2022 (JP) 2022-161726

(51) Int. Cl. H01M 50/298; H01M 10/42; H01M 50/507

(52) U.S. Cl. CPC H01M 50/298; H01M 10/425; H01M 50/507

(57) ABSTRACT

A wiring module is to be to be attached to a battery stack configured by stacking a plurality of power storage elements including electrode terminals, and provided with at least one first wire and a protector including an accommodating portion extending in a routing direction, the first wire being routed in the routing direction, and configured to accommodate the first wire. The accommodating portion includes a bottom portion, at least one first side piece extending in a first direction orthogonal to the routing direction from one side edge of the bottom portion, at least one side piece extending in the first direction from the other side edge of the bottom portion, at least one first space provided adjacent to the first side piece in the routing direction and at least one second space provided adjacent to the second side piece in the routing direction.

### TECHNICAL FIELD

The present disclosure relates to a wiring module.

### BACKGROUND

In a high-voltage battery pack used in an electric vehicle, a hybrid vehicle or the like, a multitude of battery cells are normally stacked and electrically connected in series or in parallel by a wiring module. A wiring module described in Japanese Patent Laid-Open Publication No. 2016-122577 (Patent Document 1 below) has been conventionally known as such a wiring module.

The wiring module described in Patent Document 1 is provided with a busbar, a temperature detecting member and an insulating protector for holding the busbar and the temperature detecting member. Each of the busbar and the temperature detecting member is connected to a device outside the wiring module via a wire. The insulating protector includes wire accommodation grooves for accommodating the wires. Restricting pieces projecting from one groove wall portion to the other groove wall portion are provided on the upper end edges of a pair of the groove wall portions of the wire accommodation groove. The restricting pieces restrict the wire from protruding from the wire accommodation groove. The restricting pieces are provided on both of the pair of groove wall portions and a pair of the corresponding restricting pieces are disposed to approach each other.

### PRIOR ART DOCUMENTS

### Patent Document

Patent Document 1: JP 2016-122577 A

### SUMMARY OF THE INVENTION

### Problems to be Solved

In the above configuration, when the wire is accommodated into the wire accommodation groove, an operation of making an interval between the pair of restricting pieces facing each other wider than an outer diameter of the wire and introducing the wire into between the pair of restricting pieces by deflecting the restricting pieces is necessary.

In the wiring module of this type, a configuration capable of more easily routing the wires in the insulating protector is desired.

### Means to Solve the Problem

The present disclosure is directed to a wiring module to be attached to a battery stack configured by stacking a plurality of power storage elements including electrode terminals, the wiring module being provided with at least one first wire and a protector including an accommodating portion extending in a routing direction, the first wire being routed in the routing direction, the accommodating portion accommodating the first wire, the accommodating portion including a bottom portion, at least one first side piece extending in a first direction orthogonal to the routing direction from one side edge of the bottom portion, at least one second side piece extending in the first direction from the other side edge of the bottom portion, at least one first space provided adjacent to the first side piece in the routing direction and at least one second space provided adjacent to the second side piece in the routing direction, the first and second side pieces being arranged not to overlap each other in a second direction orthogonal to both the routing direction and the first direction, the first and second side pieces being deflectable and deformable in the second direction, the first side piece facing the second space on the second side piece side in the second direction, the second side piece facing the first space on the first side piece side in the second direction, the first side piece including a first claw portion projecting toward the second space from an end edge in the first direction of the first side piece, the second side piece including a second claw portion projecting toward the first space from an end edge in the first direction of the second side piece, and a minimum dimension in the second direction between the first and second claw portions is smaller than an outer diameter of the first wire.

### Effect of the Invention

According to the present disclosure, it is possible to provide a wiring module in which a first wire is easily routed.

### BRIEF DESCRIPTION OF THE DRAWINGS

FIG. 1 is a front view of a power storage module according to an embodiment.

FIG. 2 is an enlarged front view of the power storage module showing the periphery of a wire accommodating portion.

FIG. 3 is a section along A-A of FIG. 2.

FIG. 4 is an enlarged side view of the power storage module showing the periphery of the wire accommodating portion.

FIG. 5 is an enlarged perspective view of the power storage module showing the periphery of the wire accommodating portion.

FIG. 6 is a perspective view of a front part of the battery stack.

FIG. 7 is a perspective view showing an essential part of a laminated battery.

FIG. 8 is an enlarged perspective view of a power storage module according to another embodiment showing the periphery of a wire accommodating portion.

### DETAILED DESCRIPTION TO EXECUTE THE INVENTION

### Description of Embodiments of Present Disclosure

First, embodiments of the present disclosure are listed and described.

(1) The wiring module of the present disclosure is to be attached to a battery stack configured by stacking a plurality of power storage elements including electrode terminals, and provided with at least one first wire and a protector including an accommodating portion extending in a routing direction, the first wire being routed in the routing direction, the accommodating portion accommodating the first wire, the accommodating portion including a bottom portion, at least one first side piece extending in a first direction orthogonal to the routing direction from one side edge of the bottom portion, at least one second side piece extending in the first direction from the other side edge of the bottom portion, at least one first space provided adjacent to the first side piece in the routing direction and at least one second space provided adjacent to the second side piece in the routing direction, the first and second side pieces being arranged not to overlap each other in a second direction orthogonal to both the routing direction and the first direction, the first and second side pieces being deflectable and deformable in the second direction, the first side piece facing the second space on the second side piece side in the second direction, the second side piece facing the first space on the first side piece side in the second direction, the first side piece including a first claw portion projecting toward the second space from an end edge in the first direction of the first side piece, the second side piece including a second claw portion projecting toward the first space from an end edge in the first direction of the second side piece, and a minimum dimension in the second direction between the first and second claw portions is smaller than an outer diameter of the first wire.

According to this configuration, since the first and second side pieces are deflectable and deformable in the second direction, an operation of widening an interval between the first and second claw portions and introducing the first wire into the accommodating portion by deflecting the first or second side piece is facilitated. Further, since the first and second side pieces are arranged not to face each other in the second direction, a deflection amount of the first or second side piece necessary to introduce the first wire into the accommodating portion is reduced. Therefore, the first wire is easily accommodated into the accommodating portion.

(2) Preferably, the first side piece and the first space are alternately disposed in the routing direction, and the second side piece and the second space are alternately disposed in the routing direction.

According to this configuration, since the first and second side pieces are alternately arranged in the routing direction, the first wire is easily held in the accommodating portion.

(3) Preferably, the wiring module is further provided with a second wire different from the first wire, the protector includes a routing portion for routing the second wire in the routing direction, the routing portion includes a bottom wall portion and a pair of side wall portions extending in the second direction from both side edges of the bottom wall portion, and the side wall portions double as the bottom portion.

According to this configuration, spaces taken up by the accommodating portion for accommodating the first wire and the routing portion for routing the second wire can be reduced in the protector.

(4) Preferably, the wiring module is further provided with a plurality of electrically conductive members to be connected to the electrode terminals, the protector includes through holes penetrating in the second direction, and the electrode terminals and the electrically conductive members are connected via the through holes.

According to this configuration, the protector and the battery stack are assembled in the second direction, but the first and second side pieces are deflectable and deformable in the second direction, wherefore the first wire is easily accommodated into the accommodating portion even after the protector is assembled with the battery stack.

### Detailed of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

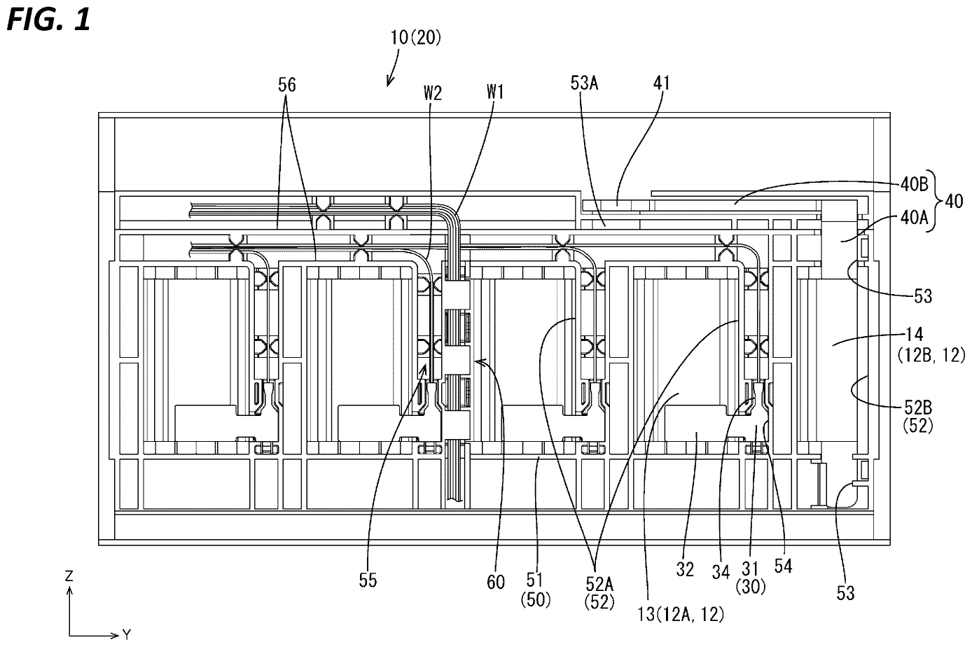

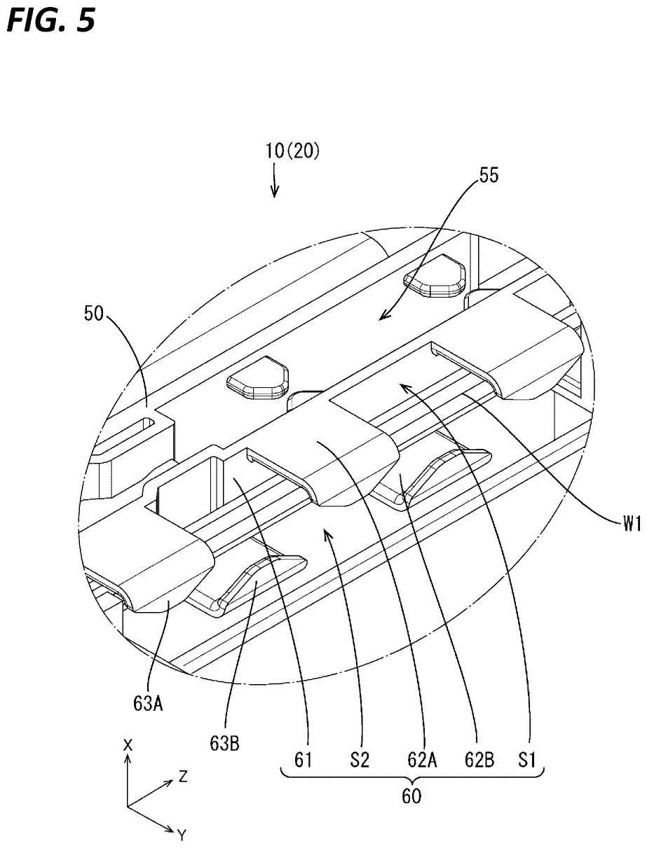

The embodiment of the present disclosure is described with reference to FIGS. 1 to 7. A power storage module 10 provided with a wiring module 20 of this embodiment is, for example, installed in a vehicle such as an electric vehicle or a hybrid vehicle and used as a drive source of the vehicle. In the following description, for a plurality of identical members, only some members may be denoted by a reference sign and the other members may not be denoted by the reference sign. A direction indicated by an arrow X is referred to as a forward direction, a direction indicated by an arrow Y is referred to as a leftward direction and a direction indicated by an arrow Z is referred to as an upward direction below. In this embodiment, a vertical direction is an example of a routing direction, a lateral direction is an example of a first direction and a front-rear direction is an example of a second direction.

### Battery Stack

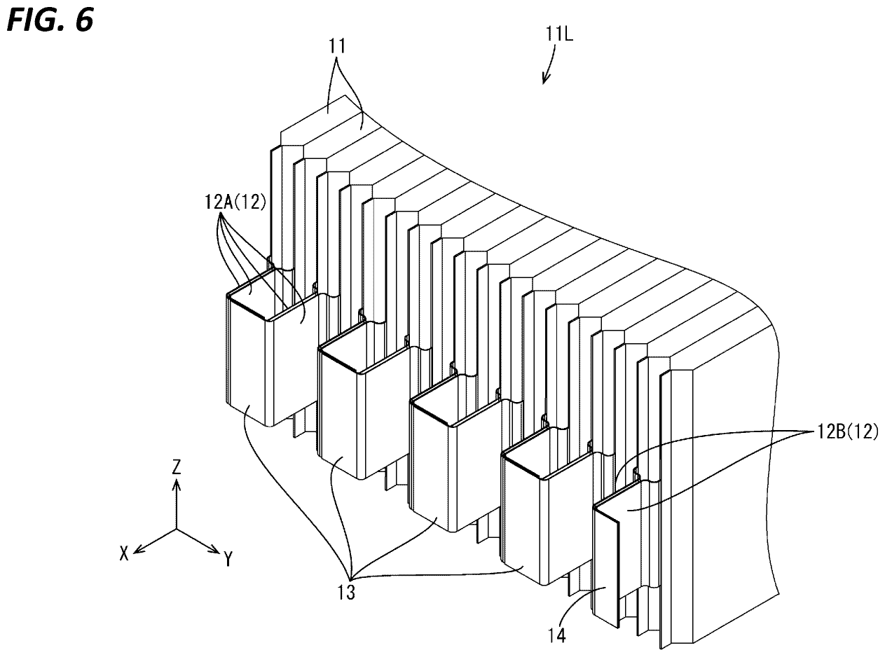

The power storage module 10 is provided with a battery stack 11L shown in FIG. 6 and a wiring module 20 to be attached to the battery stack 11L as shown in FIG. 1.

### Laminated Batteries, Electrode Leads

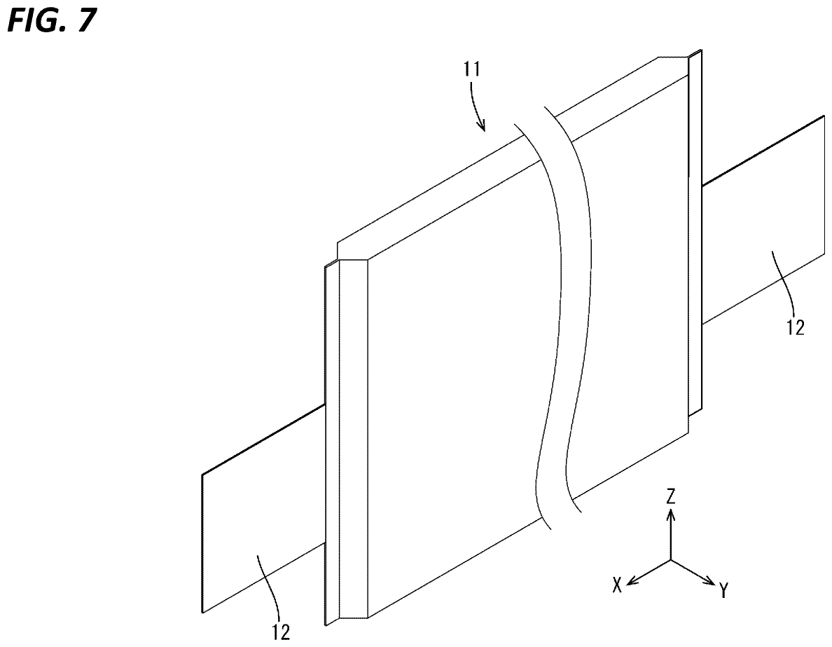

As shown in FIG. 6, the battery stack 11L is configured by stacking a plurality of (eighteen in this embodiment) laminated batteries 11 (an example of power storage elements) in a stacking direction (lateral direction). Note that only a front part of the battery stack 11L is shown in FIG. 6. As shown in FIG. 7, the laminated battery 11 has a shape long in the front-rear direction and flat in the lateral direction. A power storage element (not shown) is accommodated inside the laminated battery 11. A pair of electrode leads 12 (an example of electrode terminals) are arranged on both sides in the front-rear direction of the laminated battery 11 and project in directions opposite to each other. The pair of electrode leads 12 are plate-like and have polarities opposite to each other.

As shown in FIG. 6, the battery stack 11L is provided with joining portions 13 each for electrically connecting four electrode leads 12 of the laminated batteries 11 successively arranged in the lateral direction. That is, four electrode leads 12 are bent leftward or rightward substantially at a right angle, overlapped and joined by laser welding, whereby the joining portion 13 is configured. The electrode leads 12 constituting the joining portion 13 are connection electrode leads 12A. Out of the four connection electrode leads 12A, two connection electrode leads 12A disposed on a right side and the two connection electrode leads 12A disposed on a left side have polarities opposite to each other. For example, the two connection electrode leads 12A disposed on the right side have a positive polarity and the two connection electrode leads 12A disposed on the left side have a negative polarity. Therefore, in the battery stack 11L, the joining portion 13 connects in series two laminated batteries 11 connected in parallel. The battery stack 11L is provided with four joining portions 13 in a front part. Note that, although not shown, the battery stack 11L is also provided with four joining portions 13 in a rear part.

The battery stack 11L is provided with an output portion 14 in a left end part of the front part. Note that, although not shown, the battery stack 11L is also provided with an output portion 14 in a right end part of the rear part. The output portion 14 is configured by joining two electrode leads 12 not constituting the joining portion 13, out of the electrode leads 12. The electrode leads 12 constituting the output portion 14 are output electrode leads 12B. The two output electrode leads 12B constituting one output portion 14 have the same polarity. The output portion 14 constitutes a positive polarity or a negative polarity of the entire battery stack 11L. That is, for example, if the front output portion 14 has a total positive polarity of the battery stack 11L, the rear output portion 14 has a total negative polarity of the battery stack 11L.

### Wiring Module

As shown in FIG. 1, the wiring module 20 of this embodiment is provided with terminals 30 (examples of electrically conductive members) to be connected to the connection electrode leads 12A, busbars 40 (examples of the electrically conductive members) to be connected to the output electrode leads 12B, first wires W1, second wires W2 to be connected to the terminals 30, and a protector 50 for holding the terminals 30, the busbars 40, the first wires W1 and the second wires W2. The configuration of the wiring module 20 to be disposed on a front side of the power storage module 10 is described in detail below. Although not shown, the wiring module 20 to be disposed on a rear side of the power storage module 10 has the same configuration as the wiring module 20 to be disposed on the front side of the power storage module 10.

The busbar 40 has a plate-like shape and is formed by working an electrically conductive metal plate material. As shown in FIG. 1, the busbar 40 includes a first part 40A extending in the vertical direction and a second part 40B connected to an upper end part of the first part 40A. The first part 40A is flat in the front-rear direction. The second part 40B extends rightward from the upper end part of the first part 40A and is flat in the vertical direction. The busbar 40 is held in busbar holding portions 53 of the protector 50 and connected to the output electrode leads 12B in a vertical central part of the first part 40A. A right end part of the second part 40B is provided with a busbar side connecting portion 41.

Although not shown, the busbar side connecting portion 41 includes an insertion hole, into which a bolt is inserted. An external connection terminal (not shown) is overlaid on the busbar side connecting portion 41, and bolt-fastened to the busbar side connecting portion 41. In this way, the busbar side connecting portion 41 is electrically connected to the external connection terminal. The external connection terminal is used to connect an unillustrated external device and the power storage module 10.

The terminal 30 is provided by working an electrically conductive metal plate material. As shown in FIG. 1, the terminal 30 includes a body portion 31, a connecting portion 32 extending rightward from the body portion 31 and a wire connecting portion 34 extending upward from the body portion 31. The body portion 31 is accommodated and held in a terminal accommodating portion 54 of the protector 50. The connecting portion 32 is connected in surface contact with a part of the joining portion 13 or the connection electrode lead 12A constituting the joining portion 13. That is, the terminal 30 is not a member for connecting the adjacent connection electrode leads 12A, but a member for connecting the connection electrode lead 12A (joining portion 13) connected in advance and the second wire W2. The wire connecting portion 34 includes a crimping piece to be crimped to the second wire W2.

### Second Wires

One end of the second wire W2 is connected to the terminal 30. Although not shown in FIG. 1, the other end part of the second wire W2 is connected to an external ECU (Electronic Control Unit) or the like via a connector or the like. The ECU is installed with a microcomputer, elements and the like and has a known configuration provided with functions of detecting a voltage, a current, a temperature and the like of each laminated battery 11 and controlling the charge and discharge of each laminated battery 11. That is, the second wire W2 of this embodiment is a so-called voltage detection wire. The second wire W2 is disposed inside a routing portion 55 and a routing groove portion 56 of the protector 50.

### First Wires

The wiring module 20 is provided with a plurality of (eight in this embodiment) first wires W1. The first wires W1 are disposed inside an accommodating portion 60 and a routing groove portion 56 of the protector 50. The first wire W1 is a wire different from the second wire W2. The first wire W1 is connected to a thermistor (not shown) for measuring, for example, a temperature of the battery stack 11L.

### Protector

The protector 50 is made of insulating synthetic resin and plate-like. As shown in FIG. 1, the protector 50 includes a protector body 51 positioned with respect to the battery stack 11L. Electrode accommodation recesses 52 (examples of through holes) are provided in parallel in the lateral direction in a vertical central part of the protector body 51. The electrode accommodation recess 52 is formed to penetrate in the front-rear direction and has a rectangular shape long in the vertical direction. The electrode accommodation recesses 52 include connection electrode accommodation recesses 52A for receiving the joining portions 13 and the connection electrode leads 12A and an output electrode accommodation recess 52B for receiving the output electrode lead 12B and the output portion 14.

The busbar holding portions 53 for holding the busbar 40 are provided above and below the output electrode accommodation recess 52B. A bolt fastening portion 53A for bolt-fastening the busbar 40 is provided to the right of the upper busbar holding portion 53. The terminal accommodating portion 54 for accommodating a part of the terminal 30 is provided on an oblique left lower side of the connection electrode accommodation recess 52A.

### Routing Portions

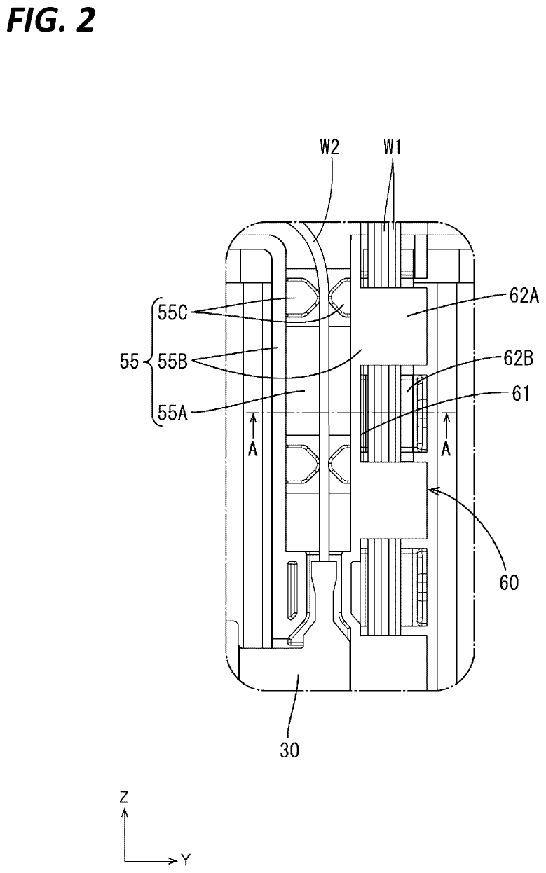

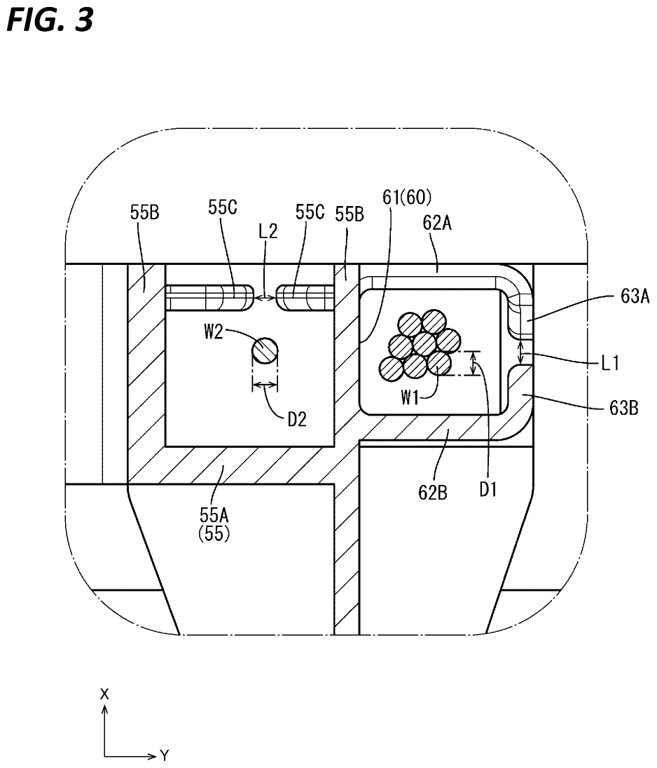

The routing portion 55 is formed to be recessed rearward from the protector body 51 on a left side of the connection electrode accommodation recess 52A. The routing portion 55 is in the form of a groove extending in the vertical direction. A lower part of the routing portion 55 communicates with the terminal accommodating portion 54. An upper part of the routing portion 55 communicates with the routing groove portion 56. As shown in FIG. 2, the routing portion 55 includes a bottom wall portion 55A and a pair of side wall portions 55B extending forward from both side edges in the lateral direction of the bottom wall portion 55A. The routing portion 55 of this embodiment includes a pair of locking pieces 55C. The pair of locking pieces 55C are facing each other in the lateral direction and extend toward each other from front end parts of the pair of side wall portions 55B. As shown in FIG. 3, the pair of locking pieces 55C suppress the second wire W2 from coming out from the routing portion 55 by pressing the second wire W2 from front. An interval L2 in the lateral direction between the pair of locking pieces 55C is set to be smaller than an outer diameter D2 of the second wire W2.

As shown in FIG. 1, the routing groove portion 56 is in the form of a groove extending in the lateral direction. Two routing groove portions 56 are provided similarly to the routing portions 55. Out of the two routing groove portions 56, the one disposed on a lower side communicates with the routing portions 55 and accommodates a plurality of the second wires W2. The routing groove portion 56 disposed on an upper side communicates with the accommodating portion 60 and accommodates the plurality of first wires W1.

### Accommodating Portion, Bottom Portion, First Side Pieces, Second Side Pieces

The accommodating portion 60 for accommodating the first wires W1 is disposed to the left of the second routing portion 55 from right. The accommodating portion 60 is in the form of a groove formed by cutting a part of a lateral wall portion. The accommodating portion 60 extends in a routing direction (vertical direction), in which the first wires W1 are routed. As shown in FIGS. 2 to 5, the accommodating portion 60 includes a bottom portion 61, a plurality of (three in this embodiment) first side pieces 62A and a plurality of (two in this embodiment) second side pieces 62B. The first side piece 62A extends leftward from the front side edge of the bottom portion 61. The second side piece 62B extends leftward from the rear side edge of the bottom portion 61. The first and second side pieces 62A, 62B are disposed not to overlap each other in the front-rear direction. The first and second side pieces 62A, 62B are deflectable and deformable in the front-rear direction. As shown in FIG. 3, the bottom portion 61 is substantially four-fifths of a front side of the side wall portion 55B disposed on the left side of the second routing portion 55 from right.

### First Spaces

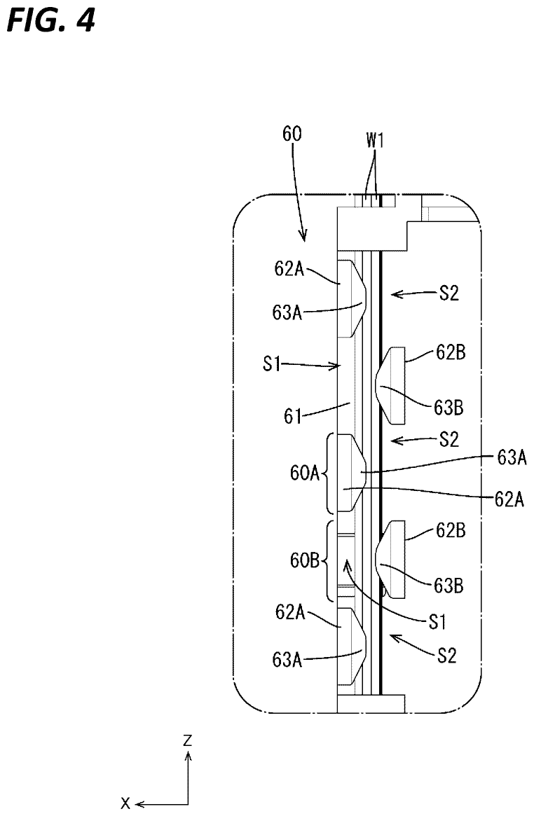

As shown in FIG. 4, first spaces S1 are provided at positions adjacent to the first side pieces 62A in the lateral direction. The accommodating portion 60 includes two first spaces S1. The first space S1 is surrounded by side edges in the vertical direction of the first side pieces 62A and the front end edge of the bottom portion 61. The second side piece 62B is disposed to face forward toward the first space S1.

### Second Spaces

Second spaces S2 are provided at positions adjacent to the second side pieces 62B in the lateral direction. The accommodating portion 60 includes three second spaces S2. The second space S2 is surrounded by side edges in the vertical direction of the second side pieces 62B and the rear end edge of the bottom portion 61. The first side piece 62A is disposed to face rearward toward the second space S2.

### First Claw Portions, Second Claw Portions

The first side piece 62A includes a first claw portion 63A projecting toward the second space S2 (rearward) from the left end edge thereof. The first claw portion 62A has a substantially trapezoidal shape in a side view and is formed to be narrower toward a tip side (rear side). The second side piece 62B includes a second claw portion 63B projecting toward the first space S1 (forward) from the left end edge thereof. The second claw portion 62B has a substantially trapezoidal shape in a side view and is formed to be narrower toward a tip side (front side). As shown in FIG. 3, a minimum dimension L1 in the front-rear direction between the first and second claw portions 63A, 63B is set to be smaller than an outer diameter D1 of the first wire W1. The first and second claw portions 63A, 63B suppress the first wires W from coming out from the accommodating portion 60 by pressing the first wires W1 from left.

In this embodiment, as shown in FIG. 4, the first side pieces 62A and the first spaces S1 are alternately disposed side by side in the vertical direction, and the second side pieces 62B and the second spaces S2 are alternately disposed side by side in the vertical direction. That is, a positional relationship of the first and second side pieces 62A, 62B is such that the first and second side pieces 62A, 62B are alternately disposed side by side in a zigzag manner in the vertical direction. In this way, the first wires S1 can be stably accommodated in the accommodating portion 60.

### Introduction of First Wires into Accommodating Portion

In introducing the first wires W1 into the accommodating portion 60, the first side pieces 62A are deflected forward and the second side pieces 62B are deflected rearward. In this way, the interval between the first and second claw portions 63A, 63B can be widened and the first wires W1 can be introduced into between the first and second claw portions 63A, 63B. That is, since not the first and second claw portions 63A, 63B, but the first and second side pieces 62A, 62B can be deflected, the first wires W1 are more easily introduced into the accommodating portion 60 as compared to the conventional structure (wire accommodation grooves of Patent Document 1, routing portions 55 of this embodiment).

Further, in accommodating the first wires W1 into the accommodating portion 60, the side piece (first side piece 62A or second side piece 62B) is disposed on one side in the front-rear direction of the first wires W1 and the space (second space S2 or first space S1) spreads on the other side. To simplify the description, a partial structure (called a first unit 60A) of the accommodating portion 60 including the first side piece 62A on the front side and the second space S2 on the rear side is described. To introduce the first wires W1 into the first unit 60A, the first side piece 62A is deflected forward so that the first claw portion 63A of the first side piece 62A does not interfere with the first wires W1. At this time, the first wires W1 may enter the second space S2 spreading on the rear side. Thus, a deflection amount of the first side piece 62A necessary to accommodate the first wires W1 into the first unit 60A is reduced. The same can be said for a second unit 60B, which is a partial structure of the accommodating portion 60 including the second side piece 62B on the rear side and the first space S1 on the front side. Therefore, in introducing the first wire W1 into the accommodating portion 60, the first and second side pieces 62A, 62B need not be largely deflected, wherefore an operation of accommodating the first wires W1 into the accommodating portion 60 is facilitated.

On the other hand, if first and second side pieces are disposed to face each other in the front-rear direction unlike this embodiment, the first and second side pieces have to be deflected so that both first claw portions and second claw portions do not interfere with first wires when the first wires are introduced into an accommodating portion. Deflection amounts of the first and second side pieces at this time are larger than the above deflection amount.

### Functions and Effects of Embodiment

According to the embodiment, the following functions and effects are achieved.

The wiring module 20 according to the embodiment is to be attached to the battery stack 11L configured by stacking the plurality of the power storage elements (laminated batteries 11) including electrode terminals (electrode leads 12), and provided with at least one first wire W1 and the protector 50 including the accommodating portion 60 extending in the routing direction (vertical direction), in which the first wire W1 is routed, and configured to accommodate the first wire W1. The accommodating portion 60 includes the bottom portion 61, at least one first side piece 62A extending in a first direction (lateral direction) orthogonal to the routing direction from one (front) side edge of the bottom portion 61, one second side piece 62B extending in the first direction from the other (rear) side edge of the bottom portion 61, at least one first space S1 provided adjacent to the first side piece 62A in the routing direction and at least one second space S2 provided adjacent to the second side piece 62B in the routing direction. The first and second side pieces 62A, 62B are arranged not to overlap each other in a second direction (front-rear direction) orthogonal to both the routing direction and the first direction and are deflectable and deformable in the second direction. The first side piece 62A is facing the second space S2 on the side of the second side piece 62B in the second direction. The second side piece 62B is facing the first space S1 on the side of the first side piece 62A in the second direction. The first side piece 62A includes the first claw portion 63A projecting toward the second space S2 from an end edge in the first direction of the first side piece 62A. The second side piece 62B includes the second claw portion 63B projecting toward the first space S1 from an end edge in the first direction of the second side piece 62B. The minimum dimension L1 in the second direction between the first and second claw portions 63A, 63B is smaller than the outer diameter D1 of the first wire W1.

According to this configuration, since the first and second side pieces 62A, 62B are deflectable and deformable in the second direction, an operation of widening the interval between the first and second claw portions 63A, 63B and introducing the first wire W1 into the accommodating portion 60 by deflecting the first or second side piece 62A, 62B is facilitated. Further, since the first and second side pieces 62A, 62B are arranged not to face each other in the second direction, the deflection amount of the first or second side piece 62A, 62B necessary to introduce the first wire W1 into the accommodating portion 60 is reduced. Therefore, the first wire W1 is easily accommodated into the accommodating portion 60.

In the embodiment, the first side piece 62A and the first space S1 are alternately disposed in the routing direction, and the second side piece 62B and the second space S2 are alternately disposed in the routing direction.

According to this configuration, since the first and second side pieces 62A, 62B are alternately arranged in the routing direction, the first wire W1 is easily held in the accommodating portion 60.

The wiring module 20 according to the embodiment is further provided with the second wire W2 different from the first wire W1, the protector 50 includes the routing portion 55 for routing the second wire W2, the routing portion 55 includes the bottom wall portion 55A and the pair of side wall portions 55B extending in the second direction from both side edges of the bottom wall portion 55A, and the side wall portions 55B double as the bottom portion 61.

According to this configuration, spaces taken up by the accommodating portion 60 for accommodating the first wire W1 and the routing portion 55 for routing the second wire W2 can be reduced in the protector 50.

The wiring module 20 according to the embodiment is further provided with a plurality of electrically conductive members (terminals 30 and busbars 40) to be connected to the electrode terminals, the protector 50 includes the through holes (electrode accommodation recesses 52) penetrating in the second direction, and the electrode terminals and the electrically conductive members are connected via the through holes.

According to this configuration, the protector 50 and the battery stack 11L are assembled in the second direction, but the first and second side pieces 62A, 62B are deflectable and deformable in the second direction. Thus, the first wire W1 is easily accommodated into the accommodating portion 60 even after the protector 50 is assembled with the battery stack 11L.

### Other Embodiments

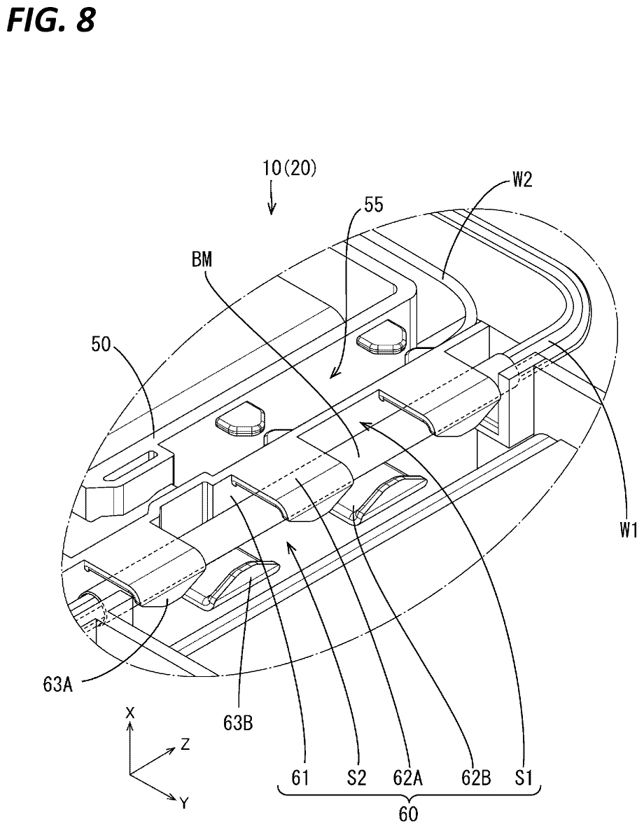

(1) Although the plurality of first wires W1 are accommodated in the accommodating portion 60 without being bundled in the above embodiment, there is no limitation to this. For example, as shown in FIG. 8, the wiring module 20 may be further provided with a bundling member BM for bundling the plurality of first wires W1 and the plurality of first wires W1 bundled by the bundling member BM may be accommodated in the accommodating portion 60. Here, a heat shrinkable tube, a corrugated tube or the like can be used as the bundling member BM. By bundling the plurality of first wires W1 by the bundling member BM, the plurality of first wires W1 can be collectively accommodated into the accommodating portion 60.

(2) Although the second wire W1 is a voltage detection wire and the first wire W1 has a configuration different from that of the second wire W2 in the above embodiment, there is no limitation to this and the first wire may be a voltage detection wire.

(3) Although the side wall portions 55B of the routing portion 55 double as the bottom portion 61 of the accommodating portion 60 in the above embodiment, there is no limitation to this. For example, the routing portion may not be provided or a routing portion may be provided and side wall portions thereof may not include a bottom portion of an accommodating portion.
(4) Although the first and second side pieces 62A, 62B are alternately arranged in a zigzag manner in the above embodiment, there is no limitation to this and first and second side pieces may not be alternately disposed.

### LIST OF REFERENCE numerals

10: power storage module
11: laminated battery
11L: electrode lead
12: electrode lead
12A: connection electrode lead
12B: output electrode lead
13: joining portion
14: output portion
20: wiring module
30 terminal
31: body portion
32: connecting portion
34: wire connecting portion
40 busbar
40A: first part
40B: second part
41: busbar side connecting portion
50: protector
51: protector body
52: electrode accommodation recess
52A: connection electrode accommodation recess
52B: output electrode accommodation recess
53: busbar holding portion
53A: bolt fastening portion
54: terminal accommodating portion
55: routing portion
55A: bottom wall portion
55B: side wall portion
55C: locking piece
56: routing groove portion
60 accommodating portion
60A: first unit
60B: second unit
61: bottom portion
62A: first side piece
62B: second side piece
63A: first claw portion
63B: second claw portion
BM: bundling member
D1: outer diameter of first wire
D2: outer diameter of second wire
L1: minimum dimension in front-rear direction between first and second claw portions
L2: interval in lateral direction between pair of locking pieces
S1: first space
S2: second space
W1: first wire
W2: second wire

1. A wiring module to be attached to a battery stack configured by stacking a plurality of power storage elements including electrode terminals, comprising:
at least one first wire; and
a protector including an accommodating portion extending in a routing direction, the first wire being routed in the routing direction, the accommodating portion accommodating the first wire,
the accommodating portion including a bottom portion, at least one first side piece extending in a first direction orthogonal to the routing direction from one side edge of the bottom portion, at least one second side piece extending in the first direction from the other side edge of the bottom portion, at least one first space provided adjacent to the first side piece in the routing direction and at least one second space provided adjacent to the second side piece in the routing direction,
the first and second side pieces being arranged not to overlap each other in a second direction orthogonal to both the routing direction and the first direction,
the first and second side pieces being deflectable and deformable in the second direction,
the first side piece facing the second space on the second side piece side in the second direction,
the second side piece facing the first space on the first side piece side in the second direction,
the first side piece including a first claw portion projecting toward the second space from an end edge in the first direction of the first side piece,
the second side piece including a second claw portion projecting toward the first space from an end edge in the first direction of the second side piece, and
a minimum dimension in the second direction between the first and second claw portions is smaller than an outer diameter of the first wire.

2. The wiring module according to claim 1, wherein:
the first side piece and the first space are alternately disposed in the routing direction, and the second side piece and the second space are alternately disposed in the routing direction.

3. The wiring module according to claim 1, further comprising a second wire different from the first wire, wherein:
the protector includes a routing portion for routing the second wire in the routing direction,
the routing portion includes a bottom wall portion and a pair of side wall portions extending in the second direction from both side edges of the bottom wall portion, and
the side wall portions double as the bottom portion.

4. The wiring module according to claim 1, further comprising a plurality of electrically conductive members to be connected to the electrode terminals, wherein:
the protector includes through holes penetrating in the second direction, and
the electrode terminals and the electrically conductive members are connected via the through holes.
